(19) United States
(12) Patent Application Publication
(10) Pub. No.: US 2008/0151049 A1
(43) Pub. Date: Jun. 26, 2008

(54) GAMING SURVEILLANCE SYSTEM AND METHOD OF EXTRACTING METADATA FROM MULTIPLE SYNCHRONIZED CAMERAS

(76) Inventors: David L. McCubbrey, Ann Arbor, MI (US); Eric Sieczka, Ann Arbor, MI (US)

Correspondence Address: SCHOX PLC, 730 Florida Street #2, San Francisco, CA, 94110, US

(21) Appl. No.: 11/957,304

(22) Filed: Dec. 14, 2007

Related U.S. Application Data
(60) Provisional application No. 60/870,060, filed on Dec. 14, 2006.
(60) Provisional application No. 60/871,625, filed on Dec. 22, 2006.

(51) Int. Cl. H04N 7/18; H04N 7/00

(52) U.S. Cl. 348/143; 348/36; 348/159; 382/154; 348/E07.085; 348/E07.086; 348/E07.091

(57) ABSTRACT

In one embodiment, the gaming surveillance system includes a camera subsystem, wherein the camera subsystem contains a means for extracting features in real-time, an image server, wherein the image server is connected to the camera subsystem, and communicates with the camera subsystem, and a client connected to the image server, wherein the client receives a data stream from the image server, wherein the data stream includes metadata. In another embodiment, the method of extracting metadata from multiple synchronized cameras includes the steps of capturing a first set of images and a second set of images from multiple synchronized cameras, processing the first set of images and the second set of images, and outputting metadata from the processed image sets.

### CROSS-REFERENCE TO RELATED APPLICATIONS

This application claims the benefit of U.S. Provisional Application No. 60/870,060, filed 14 Dec. 2006, and U.S. Provisional Application No. 60/871,625, filed 22 Dec. 2006. Both applications are incorporated in their entirety by this reference.

### TECHNICAL FIELD

This invention relates generally to the gaming surveillance field, and more specifically to a new and useful surveillance system and method of extracting metadata from multiple synchronized cameras.

### BACKGROUND

There are systems in the gaming field to automatically monitor and track the playing of a game. These systems typically include manual control of conventional mechanical pan-tilt-zoom (“PTZ”) cameras, which is expensive and impractical in many situations. There is a need in the gaming field for a new and useful surveillance system and method of extracting metadata from multiple synchronized digital electronic PTZ cameras. The present invention provides such system and method.

### BRIEF DESCRIPTION OF THE FIGURES

FIG. 1 is a schematic representation of a first preferred embodiment of the invention.

FIG. 2 is an exemplary schematic representation of an interface card used in the first preferred embodiment of the invention.

FIG. 3 is a flowchart representation of a second preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

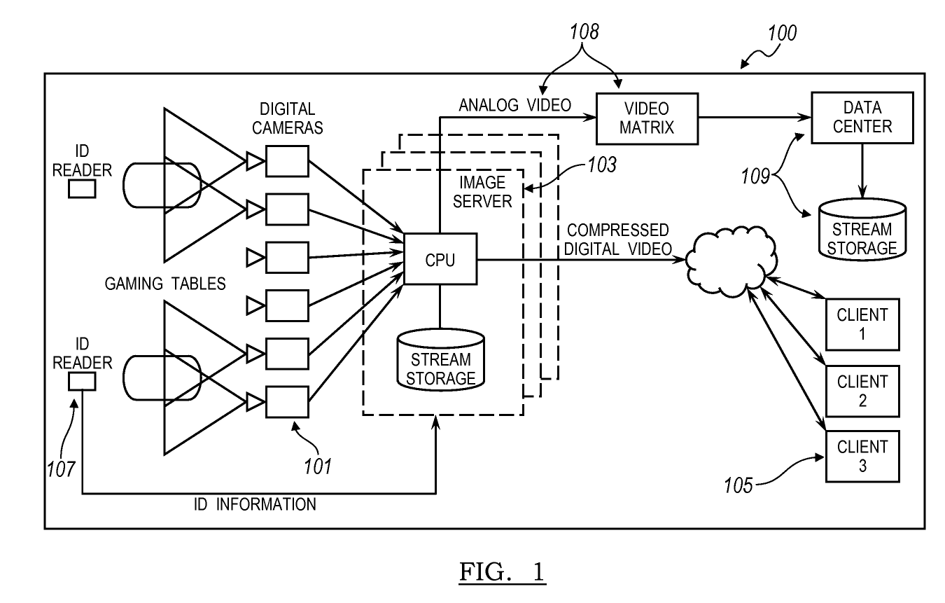

As shown in FIG. 1, the gaming surveillance system 100 according to the first preferred embodiment includes a camera subsystem 101 connected to an image server 103, and a client 105 connected to the image server 103, wherein the client 105 receives a data stream from the image server 103.

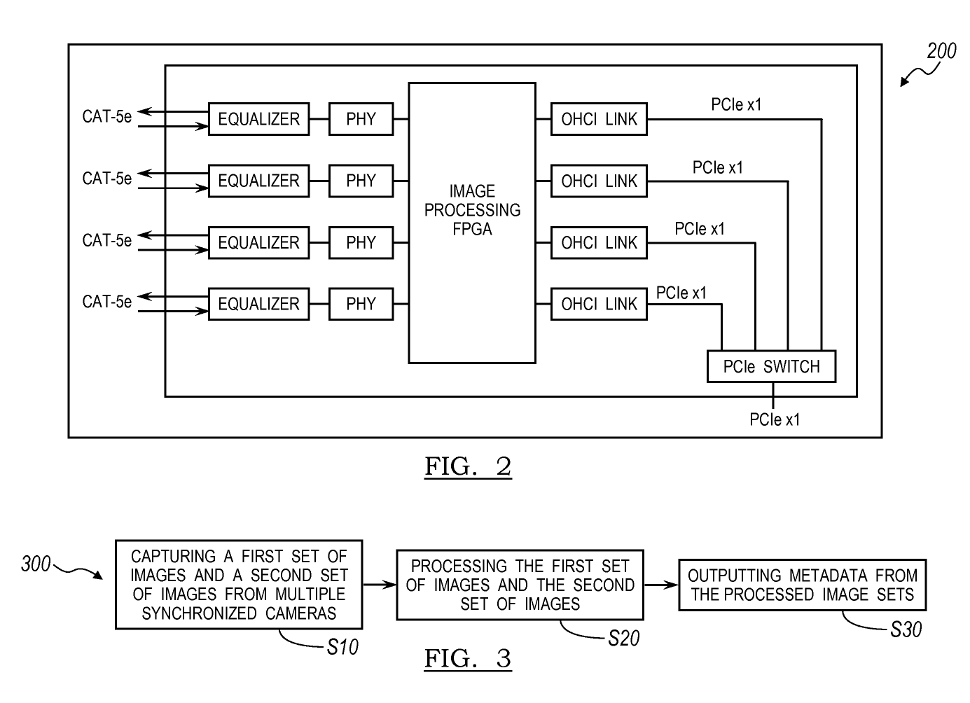

The camera subsystem 101 preferably includes at least one camera, and a means for extracting features in real-time. The camera subsystem 101 is preferably capable of independent real-time image processing for feature extraction as well as supplying simultaneous compressed and uncompressed image streams at multiple windows of interest. The camera subsystem 101 preferably provides real-time processing of uncompressed digital data at either the camera or the interface card 200 (as shown in FIG. 2). In addition, the camera subsystem 101 preferably provides the ability to allocate real-time processing functions at the camera or multi-camera level. As shown in FIG. 2, each interface card 200 is preferably connected to a group of cameras or camera subsystems 101, (preferably four cameras or camera subsystems) and preferably performs image processing and data collection on data received from those cameras. Real-time image processing services provided by the means for real time feature extraction at the interface card level preferably include multi-camera processing such as 3D depth map construction and aggregation of information supplied by multiple cameras independently. Preferably the means for extracting features in real time is an FPGA (field programmable gate array), but may alternatively be an ASIC (application specific integrated circuit), an electronic circuit, a firmware based processor, or any other suitable means for extracting features in real time. The camera subsystem 101 preferably supports conventional surveillance with analog video conversion 108 and storage capabilities 109, preferably using a video encoder, but may alternatively support any suitable system. The camera subsystem 101 is preferably positioned overhead and—in a gaming establishment (such as in a casino)—is preferably positioned with two or more over a gaming table cameras and arranged with overlapping fields of view that include both the gaming table and participants.

The image server 103 preferably receives high-resolution digital data from the camera subsystem 101, more preferably frame-synchronized cameras in the camera subsystem 101. Data from the camera subsystems 101 preferably enters via interface cards 200 (as shown in FIG. 2), where the interface cards 200 typically plug into a high capacity data bus such as PCI-Express (Peripheral Component Interconnect Express bus standard developed by Intel Corporation). The link between the server and the camera is preferably a private, low latency communications link, preferably over category 5 cable. This low latency link is preferably an IEEE 1394 link, but may alternatively be any low latency communications link. In one preferred embodiment, live high-resolution (1920×1080 pixels, for example) digital video from cameras is preferably converted to conventional reduced resolution analog (for example, NTSC) video and fed to the casino's long-term video data recording system. The image server 103 preferably records very high-resolution images for a short period to allow access to full fidelity when reviewing events. This review period is preferably a day or two, but any suitable review period may be used, such as an hour, or a week or a month. The image server 103 preferably receives instructions from any number of clients 105 to track movement of objects between images, or to provide other metadata, such as changes in position of objects between images.

The client 105 preferably receives a data stream from the image server 103. The client 105 is preferably connected to the image server 103 over a network connection. Alternatively, the client 105 may be connected internally to the image server 103, or may be a front-end software program running on the image server 103, or may be co-located with the image server 103. Preferably, the client 105 sends control signals to the image server 103 to specify regions of interest, objects of interest, and behaviors or other object properties to track. The image server preferably instructs the camera subsystem 101 to begin supplying a Region of Interest (ROI) based on the current object location and size. The image server 103 preferably relays the ROI data to the client 105 and calculates a series of new ROI locations for the camera subsystem 101 based either on prior motion attributes of the object, or the object's location in the most recent image. A region of interest (ROI) is preferably established based on the size and location of a specific object. The camera subsystem 101 is then preferably instructed by a client 105 (through the image server 105) to provide a separate image stream that follows or tracks the object as it moves. Conventionally, this action is accomplished using a standard network connection to communicate position updates. The drawback of this approach is that network communication latencies make it difficult to perform closed-loop control of the ROI location as an object moves. In the preferred embodiment, a remote client 105 may also designate an object of interest by simply touching an object or person of interest on a touch-sensitive viewing screen. This provides a simple and intuitive means of initiating an object track. The touch coordinate is preferably read off the screen and sent back to the image server 103, along with a time stamp of the image. The image server 103 preferably uses this information to initiate an object track.

Multiple types of clients 105 are preferably supported over a conventional network connection. Each type of client 105 will typically have their own additional metadata stream delivered along with either live or still images. In a first preferred embodiment, the client 105 may be security personnel interested in monitoring a game. This type of client 105 is preferably supported by an image stream sent over the network. In a second preferred embodiment, the client 105 may be another computer system running software such as a player management system. This type of client 105 will be primarily interested in a stream of image metadata information describing game events such as wagers, participant IDs, locations and time. The location and time information is preferably used by the player management software to associate image frames with game events for record-keeping purposes. Additionally, in a further variation of the second preferred embodiment, the client 105 also analyzes the behavior of a participant, based on the generated metadata, and allows the metadata to be used to evaluate a players skill level, whether or not the player is cheating, stealing, or other suspicious behavioral patterns. In one variation the metadata is used to estimate the profitability of a participant, and assist in making a business decision to close down a gaming table. In a third preferred embodiment, the client 105 may be a remote game participant. This client 105 preferably selects and controls a particular table view using remote pan, tilt and zoom commands. This type of client 105 may be interested in “following” a live participant. The participant ID metadata is preferably used to automatically route live imagery to clients.

In one further preferred embodiment, the system includes an ID terminal 107, more preferably an ID card reader, but alternatively the ID terminal 107 may be a facial recognition system, an RFID reader, a biometric reader such as an iris scanner or thumbprint scanner, or any other suitable identification system.

As shown in FIG. 3, a method 300 of extracting metadata from multiple synchronized cameras includes capturing a first set and a second set of images from multiple synchronized cameras S10, processing the first set of images and the second set of images S20, and outputting metadata from the processed image sets S30.

Step S10, which recites capturing a first set of images and a second set of images from multiple synchronized cameras, functions to capture images from multiple cameras that have been synchronized, preferably frame synchronized. In one alternative embodiment, the cameras may be partially synchronized, for example, if a frame rate of one camera were higher than another camera in the system, only certain frames would be synchronized, or the lower framerate may be interpolated to provide context for the higher framerate.

Step S20, which recites processing the first set of images and the second set of images, functions to process on the images. In one alternative embodiment, the image processing is performed on multiple images in the image set. Multiple synchronized views of the scene are used advantageously to enhance the reliability of object identification and tracking. For instance certain game objects, such as cards, have a glossy overcoat and may be difficult to read from any one view. Using multiple views maximizes the chance that a game object will be clearly visible. In addition, multiple views allow confidence metrics to be developed by noting the degree of agreement between information extracted from different views.

Multiple synchronized views also enable useful 3D information to be extracted by noting the apparent displacement of objects in two different views. Many different 3D information extraction algorithms, which are known in the art, may be applied. In addition, enhanced 3D accuracy can be obtained by taking known geometry of objects, such as dice, poker chips or cards, into account to estimate locations within a single view to sub-pixel accuracy. Highly accurate height assessments can be produced by noting slight displacements of these sub-pixel measurements. For instance, the height of a stack of poker chips may be estimated by comparing the apparent displacement between computed chip centers. Coarse 3D measurements are also of value, and may be used, for instance, in tracking the locations of players or dealers. The ability to extract feature information on a frame-by-frame multi-look basis greatly enhances the ability to track events because it allows motion tracks to be established and maintained more reliably. A longer interval between analyses increases the difficulty of associating objects observed at one time with objects observed at a different time.

When an object of interest (such as gaming objects, people, and hands) has been identified in the field of view, a “track” will be established. An object track may have certain information added or deleted as time progresses. Object tracks include information such as object type, object value, object name, object position, object size, object associations, and time. A new set of objects is preferably established at each frame. Object track information from the prior frame is preferably merged with the current frame based on physical proximity and prior direction and speed of movement. Objects may not be identifiable in every frame (due to obstruction, noise, and other factors), and in those cases, a predicted location based on prior direction and speed is preferably used.

In the event that the object being tracked is a person, Face and ID association may be accomplished by various methods, depending on how ID is established. “People Tracks” (PTs) are preferably established for all people within the system's table field of view. In most situations, new PT metadata will not initially be associated with a known ID. In a first preferred variation, ID association is preferably established by the communication between a machine-readable ID card and a card reader based on a PT's proximity to the reader at the time of the scanning event. Data obtained from the card reader is preferably automatically associated with the PT metadata. The corresponding facial front region of interest (“ROI”) view of the person is preferably added to the PT. An alert of possible false identity may be automatically generated if reference facial ID information obtained via the ID card does not match well with the captured facial front ROI image. In a second preferred variation, the PT metadata also contains ID association established by gesture tracking. In this situation, a participant sets their card upon the table. Game object identification modules identify the object as a card, but not as a playing card. An association is then made of an image ROI (encompassing the ID card) and the person's track metadata. The corresponding facial front ROI view of the person will also be added to the people track metadata.

Automatic PTZ tracking allows “close up” viewing of participants and gaming objects. A close-up is loosely defined as a framing of an object such that the scale of the object is relatively large to the viewing area (e.g., a person's head seen from the neck up, or an object of a comparable size that fills most of the viewing screen). These close-ups may be displayed on an overhead screen to generate interest for a wider audience than those sitting at the gaming table. Close-ups may also be sent to network viewing clients in order to enhance a remote gaming experience. Multiple independent close-up views may be supported using the camera's independent windows of interest capability.

Step S30, which recites outputting metadata from the processed image sets, functions to output metadata, preferably in response to requests for specific sets of metadata, for example, metadata that may be sent to multiple types of clients, such as surveillance clients, electronic data clients, or spectators. This metadata may also be in the form of object data streams, including still images, video clips, regions of interest, measurements of time, velocity, position, location, amount, viewing angle, type, size, value, name, position, association, timestamp, location, presence in camera field of view, relative physical proximity between objects, and identification or any other suitable combination of video data that may be generated from the metadata.

As a person skilled in the art will recognize from the previous detailed description and from the figures and claims, modifications and changes can be made to the preferred embodiments of the invention without departing from the scope of this invention defined in the following claims.

We claim:

1. A gaming surveillance system comprising:
a camera subsystem that includes means for extracting features in real-time;
an image server, wherein the image server is connected to the camera subsystem, and communicates with the camera subsystem; and
a client connected to the image server, wherein the client receives a data stream from the image server, wherein the data stream includes metadata.

2. The method of claim 1, wherein the camera subsystem includes two synchronized cameras having overlapping fields of view.

3. The system of claim 1, wherein the camera subsystem includes an analog video encoder.

4. The system of claim 1, wherein the camera subsystem includes an output for an additional analog video stream.

5. The system of claim 1, wherein the camera subsystem includes a camera and an interface card, wherein the interface card is connected to the camera and to the image server, and wherein the interface card includes the means for extracting features in real-time.

6. The system of claim 5, wherein the interface card is connected to the image server by a data bus.

7. The system of claim 6, wherein the data bus is a PCI-express bus.

8. The system of claim 1, wherein the means for extracting features in real-time is a field programmable gate array.

9. The system of claim 1, further including a display connected to the client that visually displays at least a portion of the data stream.

10. The system of claim 11, further comprising a touch screen user interface that sends control signals to the image server.

11. The system of claim 1, further comprising a media storage device connected to the client.

12. A method of extracting metadata from multiple synchronized cameras:
capturing a first set of images and a second set of images from multiple synchronized cameras;
processing the first set of images and the second set of images; and
outputting metadata based on the processed image sets.

13. The method of claim 12, wherein the step of processing the images includes producing a 3-dimensional image.

14. The method of claim 12, wherein the step of processing the images further includes fusing a set of images.

15. The method of claim 12, wherein the metadata is at least one object property selected from the group consisting of type, size, value, name, position, association, timestamp, location, presence in camera field of view, relative physical proximity between objects, and identification.

16. The method of claim 15, wherein the metadata is a change in an object property between the first set of images and second set of images.

17. The method of claim 12, wherein the metadata is an object track of at least one object between the first set of images and the second set of images.

18. The method of claim 17, wherein the object track is calculated by a predictive algorithm.

19. The method of claim 17, further comprising the step of transmitting an object track in a separate data stream.

20. The method of claim 17, further comprising the step of classifying the metadata according to statistical models.

21. The method of claim 20, further comprising the step of detecting cheating and stealing based on the metadata classification.

22. The method of claim 20, further comprising analysis of betting behavior by a decision engine based on the metadata classification.

23. The method of claim 22, further comprising estimating a profitability of a particular gaming participant based on the analysis of the betting behavior of the particular gaming participant by a decision engine.
